(19) United States
(12) Patent Application Publication
(10) Pub. No.: US 2004/0156038 A1
(43) Pub. Date: Aug. 12, 2004

(54) METHOD AND APPARATUS FOR PROVIDING REAL-TIME CHROMATIC DISPERSION MEASUREMENT

(76) Inventor: Xiang-Dong Cao, Boca Raton, FL (US)

Correspondence Address: XIANG-DONG CAO, 8790 TWIN LAKE DR, BOCA RATON, FL, 33496, US

(21) Appl. No.: 10/248,720

(22) Filed: Feb. 12, 2003

(51) Int. Cl. G01N 21/00

(52) U.S. Cl. 356/73.1

(57) ABSTRACT

A real time chromatic dispersion measurement arrangement measures total amount of chromatic dispersion an optical signal has gone through using a novel technique based on spectrum analyses of dispersion distorted optical signals. A novel method of dispersion measurement and monitoring is used to provide the feedback control signal for tunable dispersion compensation devices. This invention provides a simple cost-effective means for real time chromatic dispersion measurement and monitoring so that optical link dispersion can be managed or monitored dynamically without requiring expensive bit-error rate monitoring.

### BACKGROUND OF INVENTION

The present invention relates to method and apparatus for providing real time chromatic dispersion measurement in high-speed optical transmission networks and systems.

Chromatic dispersion of transmission optical fibers is one of the most important limiting factors for high-speed optical communications. Expensive lasers and external modulators are required for long distance high capacity transmission systems. For ultra-long haul dense wavelength division multiplexed (DWDM) systems, it is crucial to accurately compensate for chromatic dispersion. It is often required to measure the dispersion values of optical links before installation. Phase-shift method based on multi-wavelength sources is the most common method used to measure chromatic dispersion of transmission fibers. There are several drawbacks of phase-shift method in practical applications. First, well-trained engineers are required to perform the measurement on a span-to-span basis, which slow down the installation process and add overall cost. Second, the finite measurement uncertainty becomes unacceptable for high-capacity ultra-long haul transmission. Thirdly, the measurement requires two-end operation meaning that the received signal has to be looped back to the transmit end, which is undesirable for long spans of fiber. Fourth, the dispersion values are not real time in the sense that temperature dependence is not taken into consideration.

In this Invention, a novel technique based on tunable dispersion compensators and transmission signal processing provides accurate real-time dispersion measurement. Compared to prior solutions, this Invention has the following advantages: (1) No need to loop-back received signal; (2) Real time measurement; (3) No measurement error due to fiber length. (4) Low cost; (5) The dispersion measurement device can be integrated into the transmission system.

### SUMMARY OF INVENTION

The present invention is directed to method and apparatus for providing real time chromatic dispersion measurement using a novel technique based on spectrum analyses and signal processing of dispersion distorted optical signals. Compared to prior art, the present invention has the advantages of, (1) No need to loop-back received signal; (2) Real time measurement; (3) No measurement error due to fiber length. (4) Low cost; (5) The dispersion measurement device can be integrated into the transmission system, which can greatly improve performance of high capacity optical transmission systems and lower the overall system cost.

Viewed from one aspect, the present invention is directed to an optical arrangement for providing real time chromatic dispersion measurement to dispersion distorted input optical signal. The optical arrangement comprises a tunable dispersion unit, a high-speed photo-detector, a spectral power monitor and a digital signal-processing unit. The Invention is based on the relationship between the spectral power and the total chromatic dispersion. A real-time dispersion mapping can be obtained by adjusting the tunable dispersion unit while measuring the relative radio-frequency (RF) spectral power. The accumulated dispersion of the input optical signal can be obtained by subtracting the added dispersion of the tunable dispersion compensator. In practical applications, it is often not necessary to know the input dispersion as long as the device can completely compensates for it. Two spectral power of the detected electrical signal are measured in order to make the measurement independent of input optical power.

### BRIEF DESCRIPTION OF DRAWINGS

FIG. 1 is a block diagram of real-time chromatic dispersion measurement arrangement with a first embodiment of the present invention;

FIG. 2 graphically shows a typical relationship between the normalized tone power and total chromatic dispersion.

The drawings are not necessarily to scale.

### DETAILED DESCRIPTION

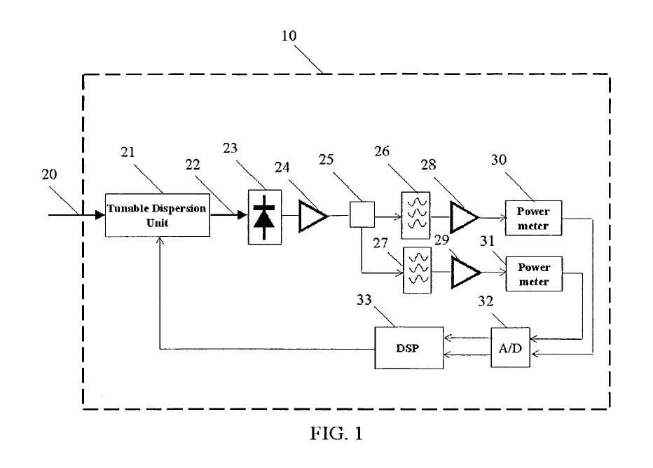

Referring now to FIG. 1, there is shown a block diagram of a real-time chromatic dispersion measurement arrangement 10 (shown within a dashed line rectangle) in accordance with a first embodiment of the present invention. The real-time chromatic dispersion measurement arrangement 10 comprises a tunable dispersion unit 21, a broadband photo-detector 23, a broadband amplifier 24, an electrical splitter 25, a narrow band RF band-pass filter 26, a low-pass filter 27, a narrow band amplifier 28, a DC amplifier 29, a narrow band RF power monitor 30, a DC power monitor 31, an A/D converter 32, and a digital signal processing unit 33.

In operation, a dispersion distorted optical input signal is received by the real-time chromatic dispersion measurement arrangement 10 via the optical input fiber 20, which is coupled to the input of the tunable dispersion unit 21. The output of tunable dispersion unit 21 is connected to the high-speed photo-detector 23 via optical fiber 22. A broadband amplifier 24 can be either integrated with the photo-detector 23, or stand-alone. An electrical splitter 25 splits the received electrical signal into two passes, one directed to a band-pass filter 26, the other to a low-pass filter 27. Power amplifiers 28 and 29 can be integrated with filter 26 and 27, respectively, such as active filters. The center frequency of band-pass filter 26 is equal to the bit-rate of the input optical signal. Power monitor 30 and 31 measures the tone power and average (DC) power, respectively. A/D 32 converts the analog tone and DC power to digital values for the digital processing 33. Digital processing unit 33 first calculates the normalized tone power by dividing the tone power with the DC power, then scan the tunable dispersion unit to a new value, and repeats the scanning and measuring till a set of data points between normalized tone power and dispersion are obtained. A minimum in normalized tone power corresponds to a zero total dispersion, meaning the dispersion of the input signal is equal to that of the tunable dispersion compensator, but opposite in sign.

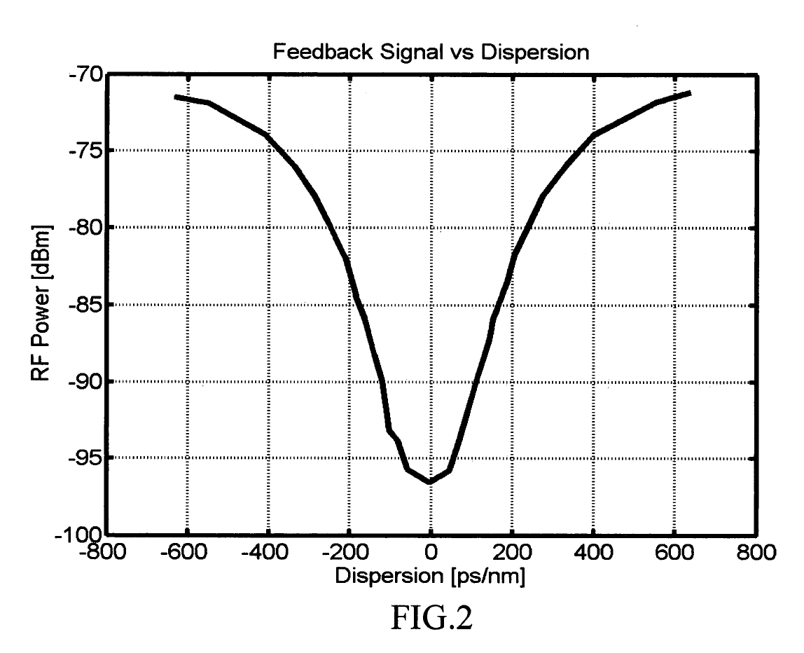

Referring to FIG. 2, a typical relationship between the normalized tone power and total chromatic dispersion is shown. The horizontal axis is the total dispersion in unit of ps/nm, while the vertical axis is the normalized tone power in unit of dB. Since the dispersion values of tunable dispersion unit is known, the dispersion of input optical signal can be obtained by finding the minimum tone power, which corresponds to zero total chromatic dispersion.

The present Invention simultaneously provides the chromatic dispersion compensation and measurement for real-time data encoded signals. The technique can be used to provide an integrated dispersion-managing device for high capacity optical transmission systems.

It is to be appreciated and understood that the specific embodiments of the invention described hereinabove are merely illustrative of the general principles of the invention. Various modifications may be made by those skilled in the art which are consistent with the principles set forth.

1. An optical arrangement for providing real-time chromatic dispersion measurement to a received dispersion-distorted input optical signal, the arrangement comprising:
a tunable chromatic dispersion compensator;
a high-speed photo-detector that converts the dispersion distorted optical signal to an electrical signal, and provides certain amount of amplification to the converted electric signal;
a broadband splitter that splits the amplified electrical signal;
a narrow-band filter that has its center pass-band frequency equal to the bit-rate of the input optical signal;
a low-pass filter that is used to limit the overall bandwidth for proper average (DC) power measurement;
a narrow-band radio-frequency (RF) power monitor;
a DC power monitor;
an analog-to-digital converter;
a digital signal processing unit;

2. The optical arrangement of claim 1 wherein the tunable dispersion compensator is used to add a certain amount of chromatic dispersion to the input optical signal.

3. The optical arrangement of claim 1 wherein high-speed photo-detector that converts the dispersion distorted optical signal to an electrical signal, provides certain amount of amplification and spectral filtering to the converted electric signal.

4. The optical arrangement of claim 1 wherein the broadband electric signal splitter is used to divide the input electrical signal into two signals.

5. The optical arrangement of claim 1 wherein the narrow band electrical filter is used to filter out the spectral tone signal of frequency of the bit-rate of the input optical signal.

6. The optical arrangement of claims 1 wherein the low-pass electrical filter is used to filter out high-frequency noise for DC power monitoring.

7. The optical arrangement of claims 1 wherein narrow band RF power monitor measures the tone power.

8. The optical arrangement of claims 1 further comprising a DC power monitor.

9. The optical arrangement of claims 1 further comprising an analog-to-digital converter that converts the analog power readings of both power monitors to digital readings that are used by the digital signal processing unit.

10. The optical arrangement of claims 1 wherein the digital signal processing unit process the input spectral powers so that the dispersion values of the input optical signal can be obtained. A relationship between the dispersion values of the tunable dispersion compensator and the normalized spectral tone power, obtained by dividing the raw tone power with the DC power, can be obtained by tuning the tunable dispersion compensator while measuring the normalized tone power. A minimum in normalized tone power corresponds to a zero total dispersion, meaning the dispersion of the input signal is equal to that of the tunable dispersion compensator, but opposite in sign.
